(19) United States
(12) Patent Application Publication
(10) Pub. No.: US 2008/0077264 A1
(43) Pub. Date: Mar. 27, 2008

(54) Digital Audio File Management

(75) Inventors: William Irvin, Laguna Beach, CA (US); Jay Littman, Irvine, CA (US); Bradley D. Townsend, Irvine, CA (US); Matt Chalawsky, Los Angeles, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/858,761

(22) Filed: Sep. 20, 2007

Related U.S. Application Data
(60) Provisional application No. 60/846,146, filed on Sep. 20, 2006.

(51) Int. Cl. G06F 17/00

(52) U.S. Cl. 700/94

(57) ABSTRACT

Identification of a plurality of audio files, and associating at least some of the audio files with an origin code. The origin code identifies the at least some of the plurality of audio files as either a music file or a traffic file. An instruction is received from a user to display the audio files identified by the origin code as either a music file or a traffic file, and the audio files identified by the origin code as either a music file or a traffic file are displayed.

### CROSS-REFERENCE TO RELATED APPLICATION

This application claims priority to U.S. Provisional Patent Application Ser. No. 60/846,146 filed Sep. 20, 2006, and titled “DIGITAL AUDIO FILE MANAGEMENT,” the entire contents of which are incorporated herein by reference.

### FIELD

This document relates to management of digital audio files.

### BACKGROUND

Radio stations, including conventional FM and AM broadcast radio stations and Internet radio stations, now prefer digital audio files due to the ease in automating functions such as audio playback, manipulation, and scheduling. Although the use of digital media simplifies numerous tasks, challenges and broadcasting failures remain. Live air-time with periodic programming misfires and silent gaps are not uncommon, especially in systems that do not receive the higher levels of user attention that professional broadcasting systems receive. As with most automated radio systems, users must purchase and run separate music selection and traffic software, which requires the merging of logs and playlists. This process can be difficult, especially if last second changes to programs are required. This process is also difficult where broadcasting stations are controlled from remote locations, which may be desirable for convenience or to reduce costs.

### SUMMARY

In one aspect, there is disclosed a computer-implemented method for digital media management. The method includes identifying a plurality of audio files, and associating at least some of the plurality of audio files with an origin code, where the origin code identifies the at least some of the plurality of audio files as either a music file or a traffic file. The method also includes receiving an instruction from a user to display the audio files identified by the origin code as either a music file or a traffic file, and displaying the audio files identified by the origin code as either a music file or a traffic file.

In another aspect, there is disclosed a computer-implemented method for digital media management. The method includes identifying a plurality of audio files, where at least some of the plurality of audio files are associated with respective scheduled play times, receiving a user request to view the audio files that are associated with a scheduled play time, and displaying the audio files associated with a scheduled play time.

In yet another aspect, there is disclosed a computer-implemented method for digital media management. The method includes identifying a plurality of audio files, where at least some of the plurality of audio files are not associated with scheduled play times, receiving a user request to view the audio files that are not associated with scheduled play times, and displaying the audio files that are not associated with scheduled play times.

According to another aspect, there is disclosed a method for digital media management. The method includes identifying a plurality of digital media files, and displaying at least some of the plurality of digital media files to a user via a user interface, where the displayed at least some of the plurality of digital media files represent a playlist. The method also includes receiving a user selection of one of the digital media files displayed on the user interface, and displaying a log associated with the user selected digital media file, where the log identifies historical information associated with the user selected digital media file. The historical information can include real-time information associated with the file, for instance, modification history or play status of the file.

In yet another aspect, there is disclosed a method for digital media management. The method includes identifying a plurality of digital media files, displaying at least some of the plurality of digital media files to a user via a user interface, where the displayed at least some of the plurality of digital media files represent a playlist, and displaying an indication that one of the displayed digital files is currently playing.

According to another aspect, there is disclosed a method for digital media management that includes identifying a plurality of digital media files, and displaying at least some of the plurality of digital media files to a user via a user interface, where the displayed at least some of the plurality of digital media files represent a playlist. The method further includes modifying one of the digital media files displayed on the user interface in real time, and updating a log associated with the playlist to reflect the modified digital media file.

### BRIEF DESCRIPTION OF THE DRAWINGS

FIG. 1 shows an example communication system.

FIG. 2 shows an example radio broadcast system.

FIG. 3 shows an example communication connection between a workstation and a data center.

FIG. 4 shows an example screenshot of a playlist editor user interface.

FIG. 5 shows an example screenshot of a playlist editor user interface for executing library searches.

FIG. 6 shows an example screenshot of a playlist editor user interface for showing file details.

FIG. 7 shows an example screenshot of a playlist editor user interface for searching playlist entries.

FIG. 8 shows an example screenshot of a playlist editor user interface for editing file properties.

FIG. 9 shows an example screenshot of a playlist editor user interface for reviewing the modification history of a file.

FIG. 10 shows a block diagram flow chart illustrating a method for modifying a playlist using a playlist editor user interface.

FIG. 11 shows a block diagram flow chart illustrating a method for merging two playlists.

FIG. 12 shows a block diagram flow chart illustrating methods for displaying file history information, searching for files, and updating detailed information associated with files.

### DETAILED DESCRIPTION

The present disclosure is described more fully hereinafter with reference to the accompanying drawings, in which some, but not all implementations are shown. Indeed, these implementations can take many different forms and should not be construed as limited to the implementations set forth herein; rather, these implementations are provided so that this disclosure will satisfy applicable legal requirements. Like numbers refer to like elements throughout.

The following disclosure describes systems for managing digital multimedia, such as digital audio, and discloses efficient and easy to use graphical user interfaces (UIs) that can display all or any portion of a library of digital files entered into the system to allow a user to add, drop and edit files shortly (e.g., seconds) before live airtime. For example, the system can provide a radio station or production studio the ability to schedule songs, promotions and spots, or other audio files in a digital file format, in real time or near real time.

Once the scheduled files or events have been entered, a separate on-air studio UI utilized by a controller such as a disc jockey is updated in real time or near real time, such as the “SS32” UI described in detail in U.S. patent application Ser. No. 11/305,891, filed Dec. 15, 2005, and titled “Digital Media Management System and Method”, the contents of which are incorporated by reference as if set forth fully herein. The digital files can be played manually by an active user, such as a disc jockey, announcer, or station manager, or can be played automatically, either in part or in full. Additionally, a user can edit any part of the schedule, as needed, either before or during live airtime, in real time or near real time.

Any type of audio file format can be used with the system, such as .wav, .mp3, .wma, .cda, .ogg, protected AAC format, or the like. Further, according to an implementation the system can run on any standard or specialized personal computer and can be designed for any existing operating system, including but not limited to Linux, Windows NT, Windows 2000 and Windows XP.

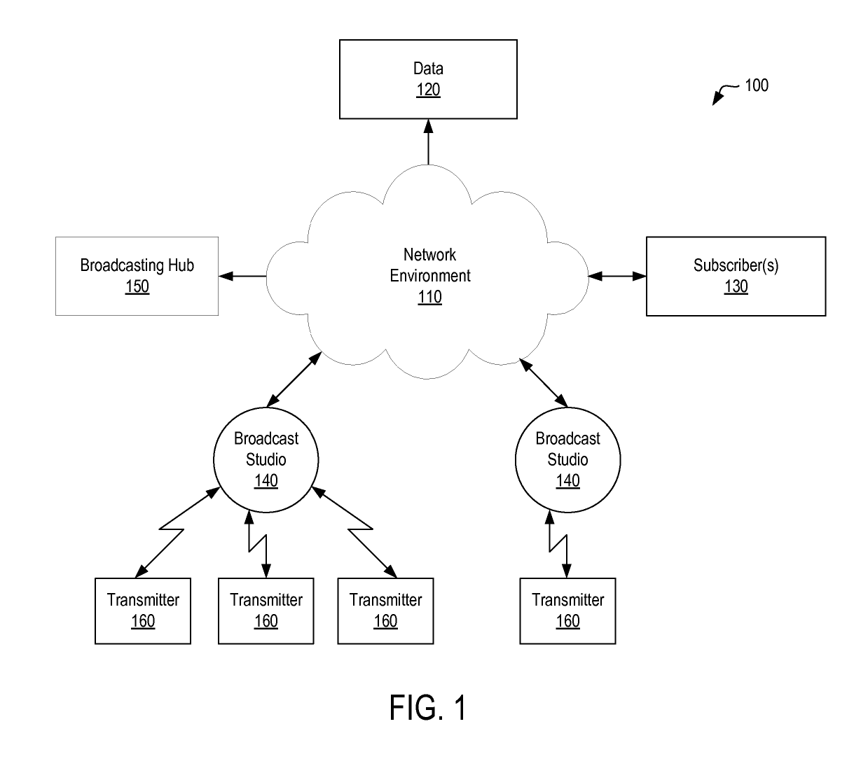

Referring now to FIG. 1, an example communication system 100 is shown, according to an implementation. The system 100 can include a networked environment 110 communicatively coupling data 120, one or more subscribers 130, at least one broadcast studio 140, and a broadcasting hub 150. According to an implementation, each of the components in the system 100 can be geographically remote. According to another implementation, the networked environment 110 can include the Internet. According to one implementation, one or more elements of the system can be coupled without a network. The data 120 can include, for example, weather data, news data, demographic data, or the like. Additionally, the subscriber(s) 130 can represent one or more advertisers, agencies, radio stations, or the like. Further, the at least one broadcast studio 140 can represent, for example, one or more regional broadcast studios. As shown in FIG. 1, the at least one studio 140 can be further communicatively coupled to at least one transmitter 160, for instance, a radio transmitter or a transmitter over a network, such as the Internet.

The broadcasting hub 150 can be configured with broadcasting platform software to store and forward verification of broadcast information of radio advertising and radio programming from at least one broadcast studio 140. According to an implementation, this verified information can be forwarded to a data recorder for recordation of a sample of the information. Furthermore, the recorded verified information can be parsed into campaign information and the remainder of the broadcast information, where the campaign information can include radio advertising or radio programming information associated with a broadcast event. The data recorder can make accessible the verified information to the networked environment 110 such that a myriad of verified information can be accumulated as necessary. The networked environment 110 can forward the verified information to a subscriber 130 and/or the broadcasting hub 150 responsive to a request for the verified information.

The system 100 permits the identification of when a radio advertisement or radio program is broadcast. This identification can be performed utilizing the broadcasting tools (e.g., software) within broadcasting hub 150. Within the broadcasting hub 150 a data collector (not illustrated) can identify verification of broadcast information related to an audio file associated with an advertising campaign or radio program, and can forward that information to the networked environment 110. In one implementation, the broadcasting hub 150 includes software for tabulating and formatting the information into a serviceable report, such as in response to a request by the subscriber 130. The information in such a report can be presented based on many different criteria, such as, for example, the total number of advertising or programming broadcasts per campaign, a listing of which stations the radio advertisement or program was broadcast over, an hourly breakdown of the broadcasts, the demographics of the broadcast audience, the geography of the broadcast audience, and/or the format of the radio stations.

According to an implementation, the reports available to the subscriber 130 can reflect the latest information available. The verification of broadcast information can be forwarded from the data collector of the broadcasting hub 150 to the networked environment 110, such as when the verification of broadcast information becomes available from the broadcast hub 150. Such a substantially real-time report can provide the subscriber 130 with substantially real-time data regarding the delivery of radio advertisements and radio programs.

According to an implementation, the verification of broadcast information associated with advertising campaigns or programs can be combined with other information, and can be stored in databases either resident on or accessible by the networked environment 110 to produce reports of demographic information about the audience of the advertising campaign or program. Such other information for combination with the verification information can be obtained, for example, from relevant Internet or intranet sites, either automatically in response to an instruction included with the submission of the program to be broadcast, or manually upon receipt of a subscriber request.

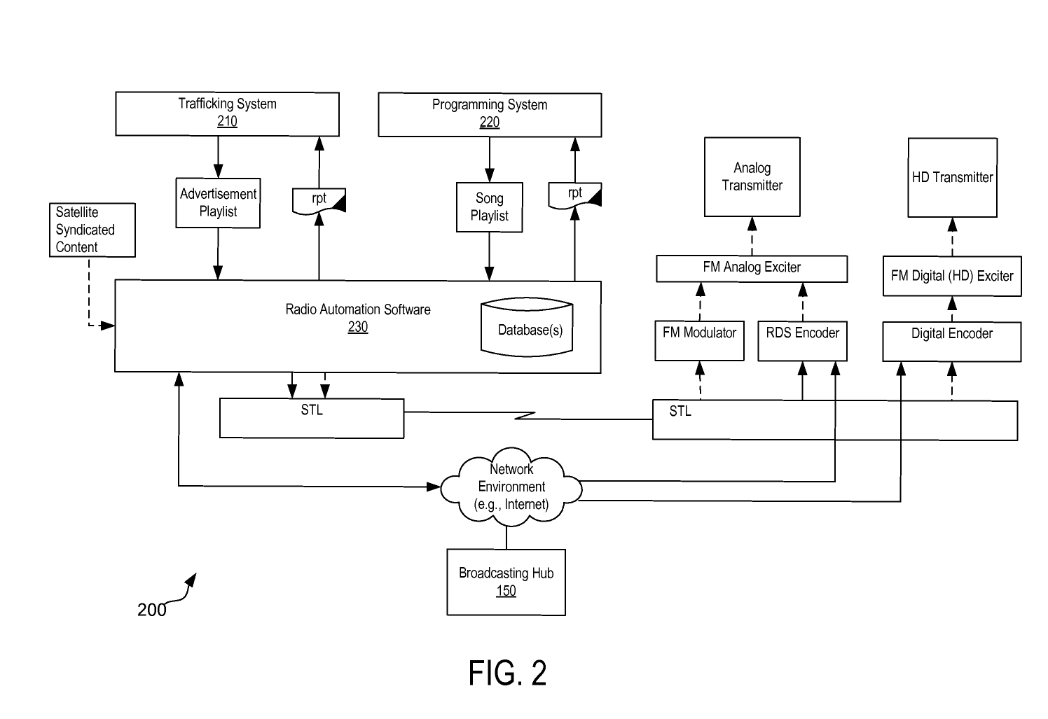

FIG. 2 shows an example radio broadcast system 200 that uses the broadcasting software platform of the broadcasting hub 150. A subscriber 130 can conduct one or more broadcast or advertising campaigns by purchasing radio advertisements across several radio stations. A subscriber 130 can distribute audio commercials to the radio stations for scheduling by a broadcast studio 140 and can verify the delivery and track the broadcast of each of the one or more advertising campaigns and associated audio commercials. According to an implementation, a subscriber 130 can identify the one or more advertising campaigns with a unique and corresponding file name. In this regard, each audio commercial digital file can have a subscriber 130—associated, unique file name. The audio commercial digital files associated with the advertising campaigns are ‘campaign creatives.’

According to an implementation, the broadcast studio 140 can also include broadcasting software to broadcast a campaign creative for a subscriber 130. The broadcast studio 140 can initiate a broadcast of the campaign creative by scheduling broadcast delivery within its trafficking system 210 or programming system 220. The trafficking system 210 and programming software 220 can include software. The campaign creative can be loaded onto radio automation software 230 of the station 140. The broadcasting software platform, denoted as radio automation software 230, can include the scheduling and/or “flight” information as provided by the trafficking system 210 and the programming system 220. In alternative implementations, the radio animation software 230 can include the trafficking system 210 and the programming system 220, such that the radio animation software 230 can include the functionality of all three systems in a single platform. The broadcast hub 150 can forward scheduling information regarding the campaign creative, captured from radio automation software 230, to the data collector. At the scheduled time, the radio automation software 230 can stream the campaign creative to a station transmitter 160 for subsequent broadcast over the air. Broadcast hub 150 can forward verification of broadcast information regarding the campaign creative, captured from the radio automation software 230, to the data collector. The data collector can accumulate and/or store the information passed from the broadcast hub 150.

According to an implementation, the data collector may isolate the verification of broadcast information related to campaign identifiers, for example, by including a table identifying the campaign identifiers. When verification of broadcast information arrives regarding one of the campaign identifiers in the campaign identifier table, the data collector may forward that verification of broadcast information (“campaign information”) to hub 150. The data collector can forward the campaign information as it arrives, or on a timed basis, such as in fifteen minute increments, one-hour increments, several-hour increments, or other increment known to those skilled in the pertinent arts. The rate at which the campaign information is passed from the data collector to hub 150 may limit how current, or real-time, a report may be. According to an implementation, the data collector can be configured to provide the campaign information to hub 150 in real-time, such as not later than a few hours after the campaign information becomes available at the data collector. A portion of hub 150 can include a web server that receives the verification of broadcast information associated with each campaign identifier (the campaign information) from the data collector and stores that information on a permanent storage medium, such as a hard disk drive. The web server can tabulate the campaign information based on each campaign identifier. The table containing the campaign information may be as current as the rate at which the data collector provides the campaign information to the web server. Consequently, the hub 150 via the web server may be able to generate reports of the broadcast of radio advertisements and radio programming in substantially real-time.

The hub 150 can provide access to the tabulated data over the Internet 110. Although the Internet 110 may be described as a wide area network for making the reports available to subscribers, those skilled in the art will appreciate that the system and method of the present disclosure encompasses any wide area network that allows access by subscribers to data stored on hub 150. Subscriber(s) 130 may access the hub 150 via a connection to the Internet 110. The connection to the Internet 110 may be any conventional connection that allows access to hub 150. For example, subscriber 130 may access hub 150 using TCP/IP and a conventional dial-up connection over a modem, or a dedicated connection that provides constant access. The hub 150 may have a unique HyperText Transfer Protocol (HTTP) address, a unique FTP address, or any other addressing scheme that allows subscriber 130 to identify hub 150.

The hub 150 may include server software, such as within a web server, that may allow subscriber 130 to request a report of a particular radio advertisement broadcast or radio program broadcast at any time. For example, a subscriber 130 may connect to internet 110 in the middle of the day on a Tuesday. At that time, the subscriber 130 may log on to hub 150 using a secure access protocol and issue a request to the web server to provide a report. The issued request identifies the particular radio advertisement or radio program of interest by campaign identifier. Hub 150 may respond to the request by reading the data stored in the table of campaign information associated with the campaign identifier provided by subscriber 130. Software resident on the web server may tabulate the report in accordance with the request. Finally, the web server publishes, such as in HTML or XML format, for example, the report to subscriber 130. In this manner, subscriber 130 may access and query the web server as frequently as desired to determine the broadcast of a particular advertising campaign or radio program.

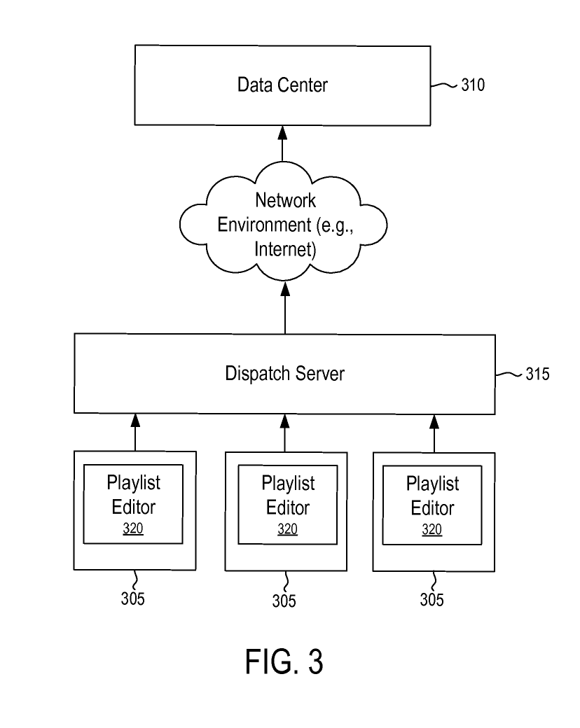

FIG. 3 illustrates an example communications connection between one or more workstations 305 and a data center 310. A local proxy can use the broadcasting software platform, shown in FIG. 3 as the playlist editor 320, along with the local proxy to create an encrypted and secure connection to the data center 310. To effect this, the playlist editors 320 can be present on each of the on-air automation workstations along with a local proxy module within the network. To establish the encrypted connection with the data center, the local proxy modules can rely on the station to have a dedicated internal automation system LAN and a separate corporate LAN with Internet connectivity. According to an implementation, there may be a dispatch server 315 that is multi-homed and includes two network cards and be aware of both networks. With both modules and hardware/network configuration in place, the broadcasting software platform can automatically attempt to connect to the local proxy. The local proxy can, in turn, attempt to establish an encrypted connection with the data center 310.

It should be understood that the broadcasting system 100 can be used not only for any standard or traditional radio broadcast, but also for Internet or network based broadcast, and for any type and combination of audio, video or other multimedia play. It should also be understood that the broadcasting system can allow a user to access and/or monitor multiple radio stations and/or production studios remotely, provided such stations and/or studios are connected within a network, such as a Wide Area Network (“WAN”) or a Local Area Network (“LAN”). For example, and referring back to FIG. 1 generally, multiple radio stations positioned across the United States can be connected via the Internet to a single hub. From the hub, a manager can oversee and edit playlists and other scheduled clips in any of the radio stations as needed. In another example, multiple studios located within a single building can be connected via a LAN to a central hub, where, as mentioned previously, a manager can oversee and make edits to files in any of the studios as needed.

As referenced above, the broadcasting software platform at the hub 150 can include a playlist editor, which can be of the form of software that provides an efficient and easy to use UI that allows a user to add, drop and edit digital media files merely seconds before live airtime. Alternatively, the playlist editor may reside locally to each radio station and can communicate with audio files and data stored at the hub 150 via one or more networks. Briefly, the playlist editor interfaces with the log of audio files to be played by an on-air studio. Each radio station managed by the playlist editor is operable to routinely check with the playlist editor and to communicate any changes in the schedule to the on-air studio. Changes may be communicated to drop boxes, or files, associated with music, traffic, and the like, for each radio station. In one implementation, the hub 150 may check for changes in each drop box periodically, such as once every ten seconds, to perform updates to a radio station's playlist.

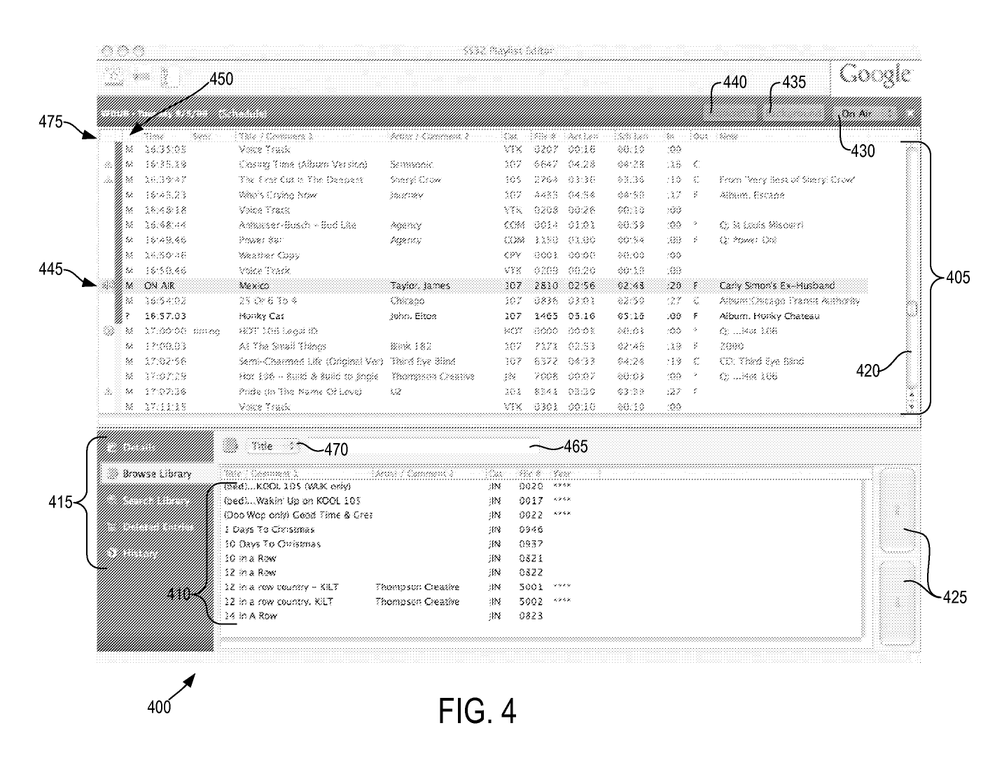

According to one implementation, the playlist editor is a tool stored on servers local to each radio station, or on a server at the hub, and is accessible to authorized users. The playlist editor can include one or more software modules for effecting the functions described in detail herein, including those described with respect to FIGS. 4-12, and may rely on one or more additional tools that are components of the playlist editor, or tools separate from the playlist editor but in communication with the playlist editor.

For instance, as described in further detail below, file searching capabilities implemented by the playlist editor via one or more UIs can utilize a search tool that is included within the playlist editor or that exists as a separate network-accessible tool. As another illustrative example described below, the merging of one or more playlists subsequent to revision using the playlist editor may be effected by radio automation software or one or more other tools operable to update playlists at the hub for real-time updates to radio stations. Therefore, each of the functions described herein can be implemented by any number of network tools, each of which can include hardware and/or software for implementing the functions described herein.

According to one implementation, the playlist editor can interface with a separate on-air studio UI that can be utilized by a DJ, for instance, the SS32 digital audio solution sold by Google. In particular, the playlist editor is used to schedule the playlist that the DJ will play or what the system will play if it is unattended. Typical users include persons associated with a radio station, such as program managers, radio station staff members responsible for scheduling events, and the like. The playlist editor can be accessed and controlled by users at the radio station or remotely via a VPN or similar network connection. Using the playlist editor users can adjust the playlist of what the radio station will play. Changes to the playlist are immediately updated and shown on the on-air studio UI utilized by the DJ, such that real-time or near real-time updates to a playlist can be effected, permitting nearly instantaneous updates to scheduled on-air programming.

FIG. 4 shows an illustrative screenshot of a playlist editor UI 400 presented by the playlist editor that permits the management of digital audio content by a user, according to an implementation. Among other functions, the playlist editor UI 400 permits a user to view digital audio files scheduled for playing, including audio files currently on air, audio files that have recently been scheduled to play, and audio files scheduled for future air play. This information is illustrated in a main pane 405 of the playlist editor UI 400.

As shown in FIG. 4, audio files are presented as line items in the main pane 405 in order of play. The current, on-air file 445 is highlighted and displayed as “ON-AIR”. Because the playlist editor permits real-time or near-real time updates to the on-air studio UI utilized by a DJ, identifying the audio file that is “ON-AIR” helps prevent a user from making changes to audio file that is either currently “ON-AIR” or about to be “ON-AIR”.

In the implementation shown, each audio file is displayed with metadata or other information associated with the audio file. The information categories for each audio file are identified in the file header 475, and can include the origin of the file, the time the audio file is scheduled to play, synchronization information, the file title, the artist name, the category of the file, the file number, the actual length of the file, the scheduled length of the file, introduction length of the file, ‘out’ information providing the fade type or other effect (e.g., ‘cut’) used to play the end of the file, and any notes associated with the file. Any other information associated with one or more files may be included in the file header 475. Additionally, the file header 475 may be customizable by the user, for instance, by selection of the columns of information displayed in the main pane 405 via right clicking on the file header 475.

Because playlists may be combined, such as a commercial playlist and a music playlist created by two different individuals, the origin category identifies the location from which an audio file originated. The individual origin codes illustrated in FIG. 4 show ‘M’ (for music) or ‘I’ (for inserted files). Alternative identifiers include ‘T’ for traffic (i.e., commercials). Additional origin codes may be used to identify one or more template layers. The use of individual origin codes for each file permits the playlist editor to execute an intelligent remerge of playlists from two or more playlists, such as a commercial playlist and a music playlist, where changes are made to one list. For instance, where changes in one playlist, e.g., a traffic playlist, are made, all traffic entries can be extracted from the combined playlist without impacting music entries. A merge can then recombine the revised traffic playlist with the unchanged music playlist. Merge points for commercial breaks in a music log may be used to effect the remerge of playlists.

Referring once again to FIG. 4, a user can control what audio files are shown in the main pane 405 using a pull down selection 430. According to one implementation, the pull-down selection 430 can include an “On-Air” selection that shows the audio file that is currently on-air in the center of the mane pane 405, as is shown in the illustrative screenshot of FIG. 4. The pull-down selection 430 can also include 24 separate hour selections to permit a user to jump forward or back in the main pane to show the audio tracks scheduled for a particular period of time. For instance if the user selects 06:00 (or 6:00 am), the main pane 405 will jump to those audio files beginning at 06:00. The user can also scroll up or down through scheduled audio files using a scroll bar 420. It should be appreciated that the pull-down selection 430 can present selections from a rolling or moving 24 hour window, such that scheduled audio files for future programming can become available for viewing each e.g., hour. Alternatively, the pull-down selection 430 includes only scheduled audio for the current day beginning at 12 am.

Users can also select one or more views of audio files shown in the main pane 405 by selection of the sequential button 440 and/or background button 435 in the playlist editor UI 400. Sequential items are those files that are not tied to a particular time, but happen in sequence. An illustrative example of a sequential item is an audio music file that plays after the event before it completes. The illustrative screenshot of FIG. 4 shows only sequential items, where the ‘time’ information for each sequential item shown in the main pane 405 represents a projected start time for the file to air. The user may also select to view only background items, which are those events that are scheduled to play at a scheduled time. An illustrative example is to automatically record a newscast provided by an outside source, such as a radio network, for playback at a later time. A user may also wish to view all items by selecting both the sequential button 440 and/or background button 435.

As described in greater detail below, a user can select an audio file shown in the main pane 405 by clicking on it. The selected audio file will be highlighted. As described in detail below, additional information on the audio file may be accessed or edited. The user can also drag and drop the audio file in a different location in the playlist, thereby changing the schedule. In one implementation, the user can also delete the entry by depressing the ‘delete’ key on the keyboard, selecting ‘delete’ from a contextual menu, or by dragging it off of the schedule. When this occurs the projected start times of each audio file provided in the main pane 405 are substantially instantly updated.

As shown in FIG. 4, the lower section of the playlist editor UI 400 provides numerous user-selectable options 415 including ‘details’, ‘browse library’, ‘search library’, ‘deleted entries’, and ‘history’. Each of the options 415 can be selected by a user for managing the playlist scheduled for playing, including permitting a user to browse and/or search all audio files that are available to a radio station, and to review a history of edits to the playlist shown in the main pane 405.

FIG. 4 illustrates a user's selection of the ‘browse library’ option, which presents the user with a inventory pane 410 providing each of the audio files available to a particular radio station that can be added to the playlist shown in the main pane 405. As shown in FIG. 4, the available audio tracks can be displayed in alphabetical order, and can be scrolled through using one or more scroll keys 425, or alternatively a scroll bar similar to that used to navigate up or down in the main pane 405. The inventory pane 410 permits a user to add an audio file to the main pane via selecting an audio track and dragging it to a desired location in the main pane. For instance, using a mouse a user could select the audio file titled “10 in a Row” by clicking on it in the inventory pane 410 and drag it into the main pane 405. Placement of the audio file in the main pane 405 by the user dictates its placement in the schedule provided by the playlist editor UI 400. For instance, if the audio file is dragged and placed between “25 Or 6 To 4” and “Honky Cat” in the example UI of FIG. 4, it will be scheduled to play immediately after “25 Or 6 To 4” and immediately before “Honky Cat”. Additionally, when a file is added to schedule shown in the main pane 405, the projected start times of each audio file provided in the main pane 405 are instantly updated.

A user can also choose to limit the library selections presented in the inventory pane 410 by entering a search term into an input window 465, where the search term identifies a particular parameter 470 associated with an audio file. For example, a user can search for songs by title, artist, music category or length of file, or any other parameter suitable for conducting a search. In one implementation, the search results provided by the inventory pane 410 dynamically change immediately upon typing into the input window 465. For instance, if the letter ‘M’ is typed into the input window, the inventory pane 410 will substantially instantly limit the inventory pane to files starting with the letter ‘M’ in alphabetical order. As additional letters are typed the results of the inventory pane 410 will be further limited. The files are shown in the inventory pane 410 information associated with the audio file including the title, artist, file and year. Although not illustrated, the inventory pane may also show additional information, including the last time a file was played, as well as the next time the file is scheduled to be played. The information identified in the inventory pane may be customizable by the user, for instance, by selection of the columns of information displayed in the inventory pane 410 via right clicking on the header of the inventory pane 410.

Additionally, although not illustrated in FIG. 4, the main pane 405 or inventory pane 410 may include a user-selectable listen button that permits a user to play a selected audio file. This may permit the user to preview a file prior to adding or deleting it from the playlist or changing its location in the playlist. The listen button may be placed elsewhere, such as in the header adjacent to the sequential button 440 to enable a user to play any selected or highlighted file.

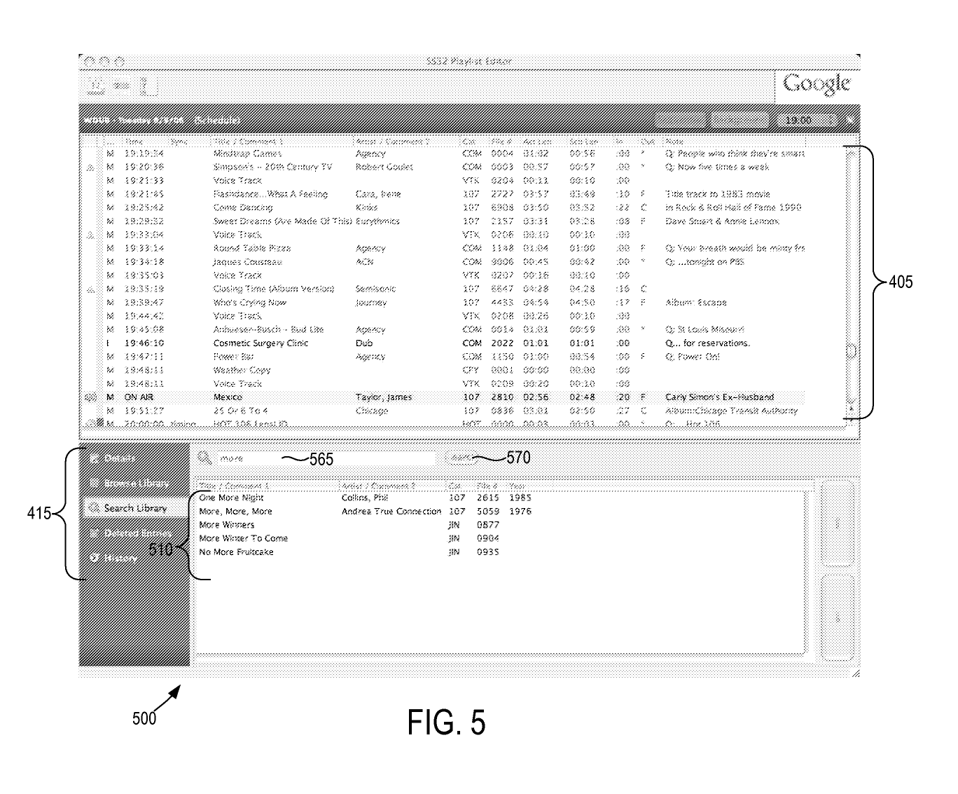

FIG. 5 shows an illustrative screenshot of a playlist editor UI 500 presented by the playlist editor for executing library searches, according to an implementation. In the illustrative screenshot of FIG. 5, the main pane 405 is the same as described above with respect to FIG. 4, however, additional detail relating to the search option is shown. Specifically, FIG. 5 illustrates the selection of the ‘search library’ option from the user-selectable options 415. The ‘search library’ option presents the user with a search pane 510 that provides the user with all files in the library that fulfill the one or more terms input by the user in the search window 565. After depressing a search button 570 the term input by the user will return all library files including the search term in metadata or other field (including title, artist, length, or other information) associated with the audio file. For example, typing ‘Madonna’ in the search pane 510 could return music files for the artist ‘Madonna’ as well as the Beatles song ‘Lady Madonna’. The search capabilities may utilize additional capabilities, including providing search results if the user enters a commonly misspelled search term. Auto-fill functions based on stored previous or popular searches may also be implemented in the search window 565. As with the inventory pane 410, the search pane 610 permits a user to add an audio file to the main pane 405 via selecting an audio track and dragging it to a desired location in the main pane.

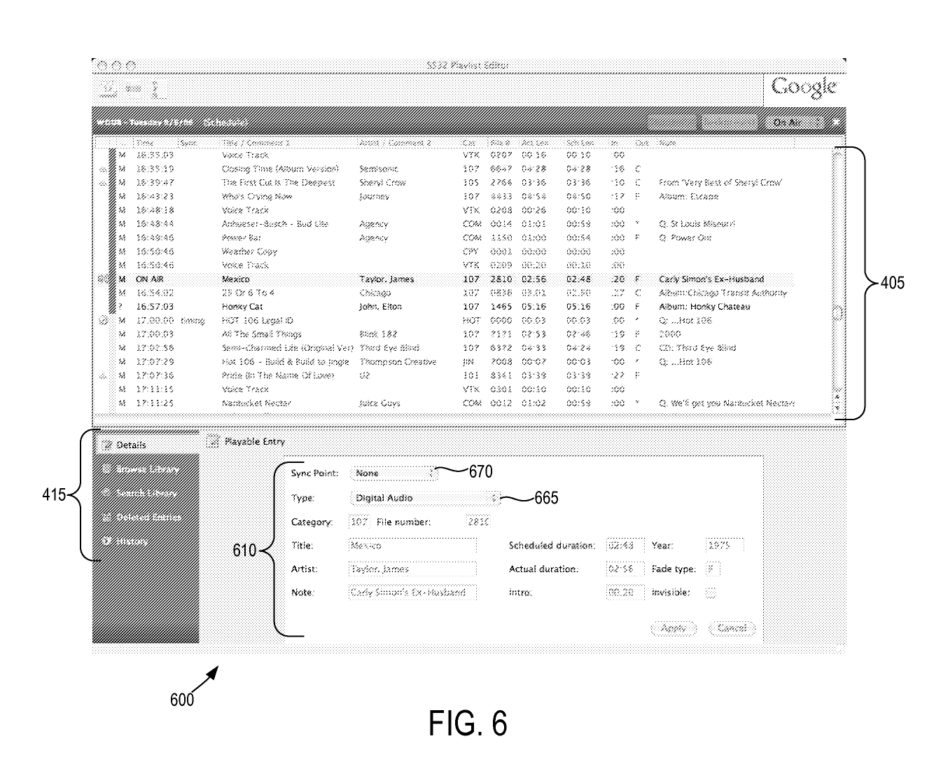

FIG. 6 shows an illustrative screenshot of a playlist editor UI 600 presented by the playlist editor that shows file details. In the illustrative screenshot of FIG. 6, the main pane 405 is the same as described above with respect to FIGS. 4 and 5, but includes additional detail. Specifically, FIG. 6 illustrates the selection of the ‘details’ option from the user-selectable options 415. The ‘details’ option presents the user with a details window 610 providing detailed information on the audio file currently selected and highlighted in the main pane 405 by the user. Using the details window 610 a user can view and modify the details associated with a selected audio file. Information associated with the audio file shown in the details window 610 includes the information categories identified in the file header 475 in the main pane 405 along with additional information including the date of the file.

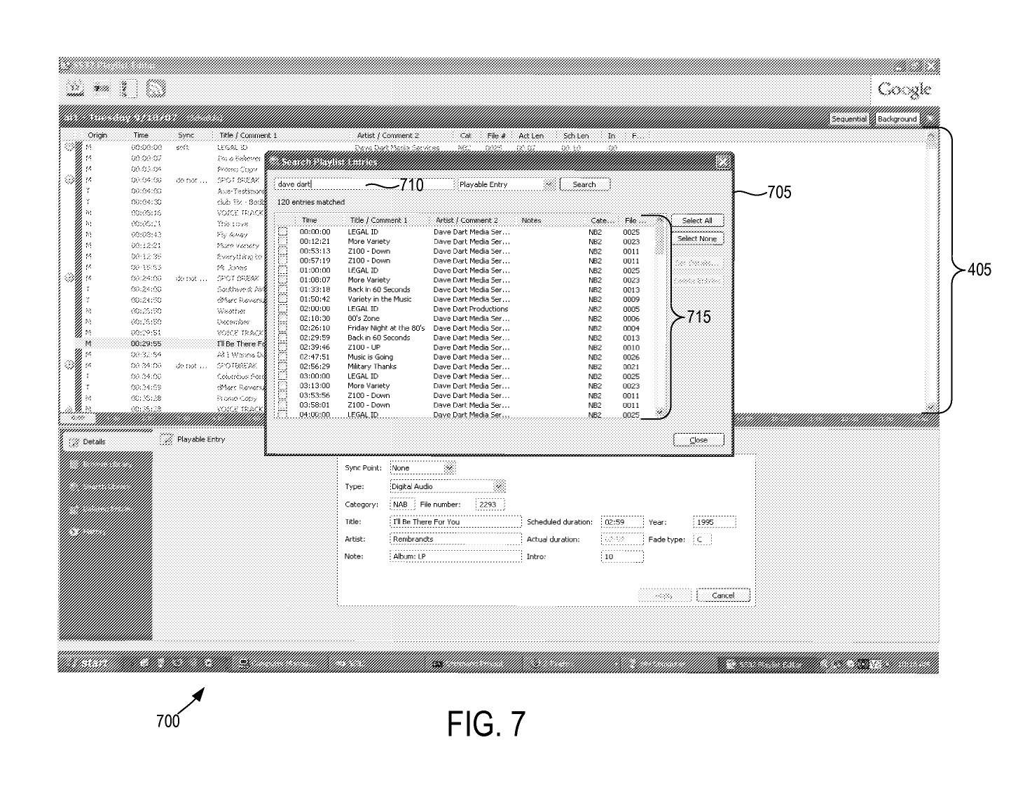

FIG. 7 shows an example screenshot of a playlist editor UI 700 presented by the playlist editor for searching playlist entries, according to an implementation. In the illustrative screenshot of FIG. 7, the main pane 405 is the same as described above with respect to FIGS. 4-6. A search playlist entries window 705 is presented to the user after the user depresses a combination of keys, for example, Ctrl+F. Although not illustrated, the search playlist entries window 705 can appear after the selection of on or more options (e.g., user-clickable or selectable buttons) on a playlist editor UI. By default the playlist entries window 705 displays all of the current playlist files in a search playlist entries window 715.

Using the search playlist entries window 705 a user can input one or more search terms in the search window 710. After selecting the search button, the search term or terms input by the user will return all library files including the search term in metadata or other field (including title, artist, length, or other information) associated with the audio files currently in the playlist. The search capabilities may utilize additional capabilities, including providing search results if the user enters a commonly misspelled search term. Auto-fill functions based on stored previous or popular searches may also be implemented in the search window 710.

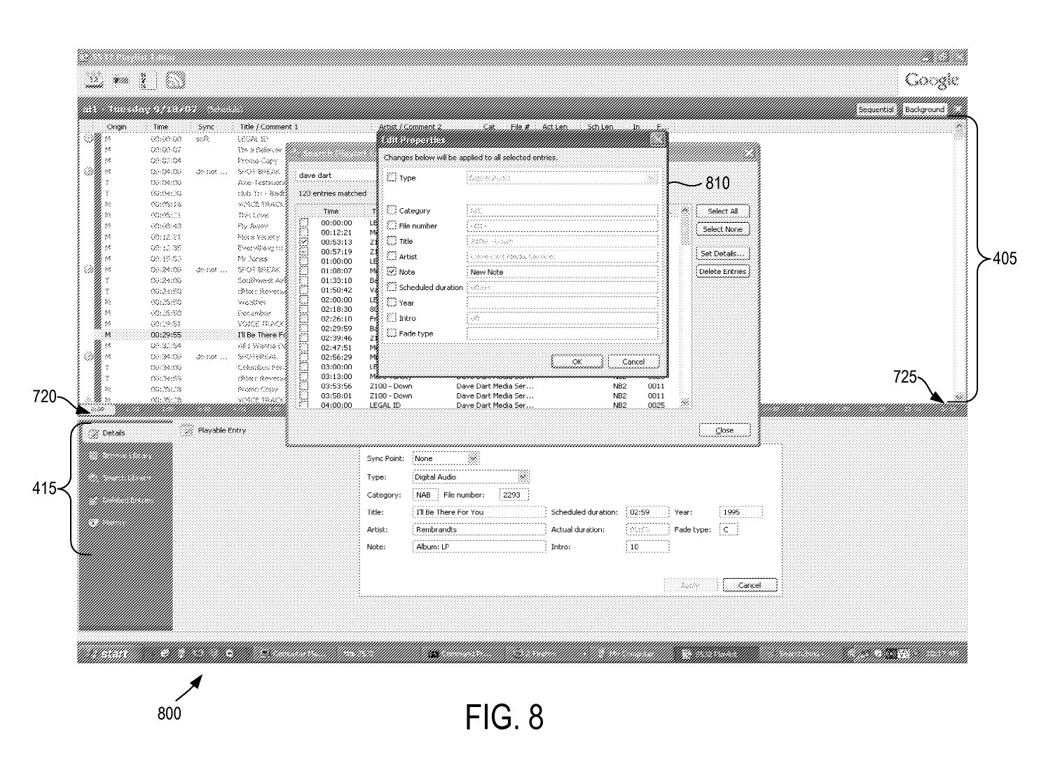

Using the search playlist entries window 705 the user can select one or more playlist entries for modification. In particular, after highlighting a particular file, a ‘set details’ button will appear, after which a file editor window will appear. According to an alternative implementation, double-clicking on a playlist entry will cause a file editor window to appear. FIG. 8 shows an example screenshot of a playlist editor UI 800 presented by the playlist editor that includes a file editor window 810, according to an implementation. The file editor window 810 enables a user to modify one or more file fields, after which the system will modify the altered file fields corresponding to the values entered by the user. Among the fields that may be modified include the file type, category, file number, title, artist, scheduled duration, year, intro, fade type, and a note.

Also shown in FIG. 8 is an alternative implementation of the ‘on air’ selection described with respect to FIG. 4, above. The “On-Air” selection that shows the audio file that is currently on-air in the center of the mane pane 405. Instead of a pull-down selection to permit a user to jump forward or back in the main pane 405 to show the audio tracks scheduled for a particular period of time, the user can select one or more hour buttons that will cause the main pane to ‘jump’ forward or back to the selected time. For instance if the user selects 06:00 (or 6:00 am), the main pane 405 will jump to those audio files beginning at 06:00.

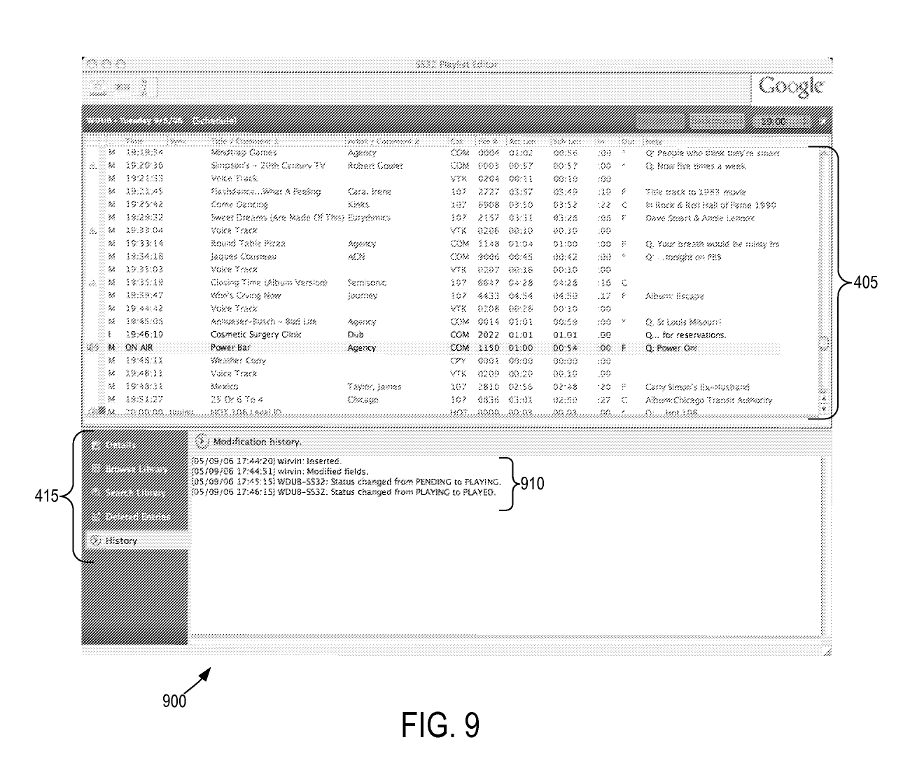

FIG. 9 shows an illustrative screenshot of a playlist editor UI 900 for reviewing the modification history of a file. In the illustrative screenshot of FIG. 9, the main pane 405 is the same as described previously with respect to FIGS. 4-8, but including additional details associated with a historical view of a media item. FIG. 9 illustrates the selection of the ‘history’ option from the user-selectable options 415. When a user selects and highlights an audio file in the main pane 405, the history pane 910 shows the history of the selected audio file. In the illustrative example of FIG. 9, the history entries for the selected audio file illustrate that the audio file was inserted at 17:44:20, one or more fields were modified at 17:44:51, the status was changed from ‘PENDING’ to ‘PLAYING’ at 17:45:15, and the status was changed from ‘PLAYING’ to ‘PLAYED’ at 17:46:15.

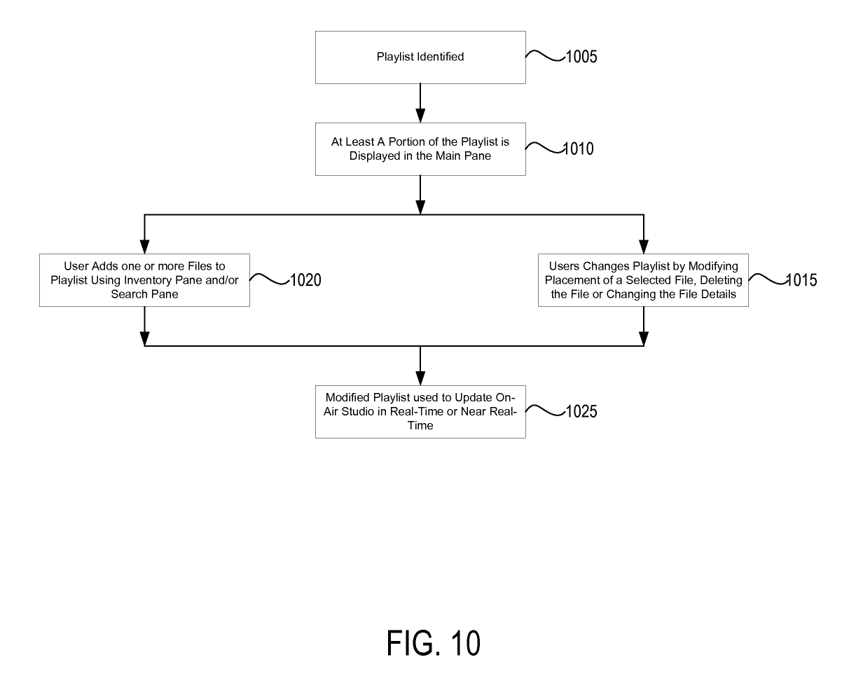

FIG. 10 shows a block diagram flow chart illustrating a method for modifying a playlist using the playlist editor UI. A playlist is identified (1005) and at least a portion of the playlist is displayed to a user in the main pane 405 of the playlist editor (1010). The user can optionally select an audio file in the main pane 405, for instance, by clicking on the audio file. Using the playlist editor the user can effect a change to the playlist by modifying the placement of the selected file, by deleting the selected file, or by changing details of the selected file (1015). A user may also use the inventory pane 410, and/or search pane 610 to select new files to add to the playlist (1020). After the user modifies the playlist, the playlist is used to update the on-air studio UI utilized by a DJ in real time (1030).

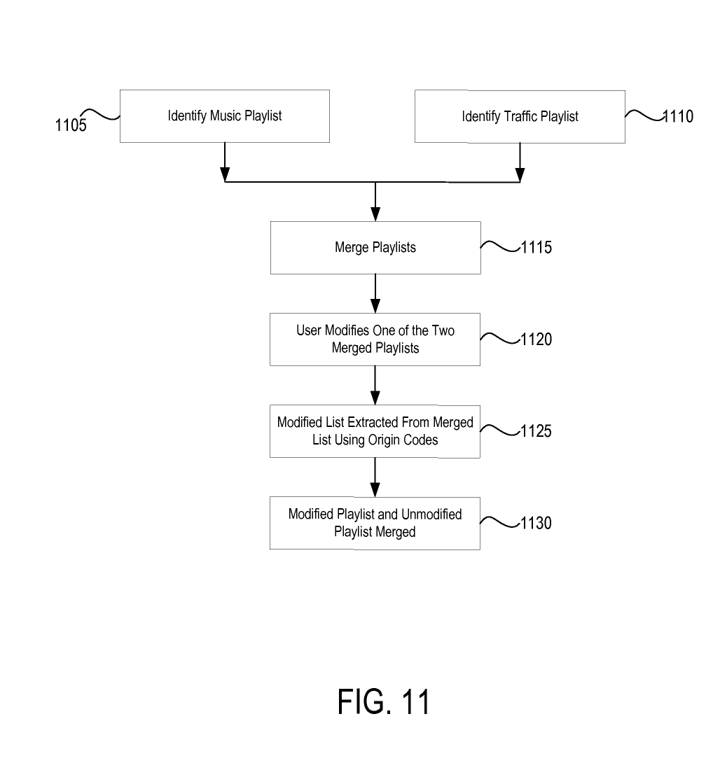

FIG. 11 shows a block diagram flow chart illustrating a method for merging two playlists. A music playlist is identified (1105) and a separate traffic list is identified (1110). The lists are then merged by the hub (1115). Subsequently, a user may modify one of the two playlists (1120). For instance, a user may wish to delete some of the files in the traffic list. To effect such changes, the modified list is extracted from the merged list using an origin code 450 associated with all entries of playlist in which changes are made (1125). Thereafter, the modified list and the unmodified list are merged by the hub (1130).

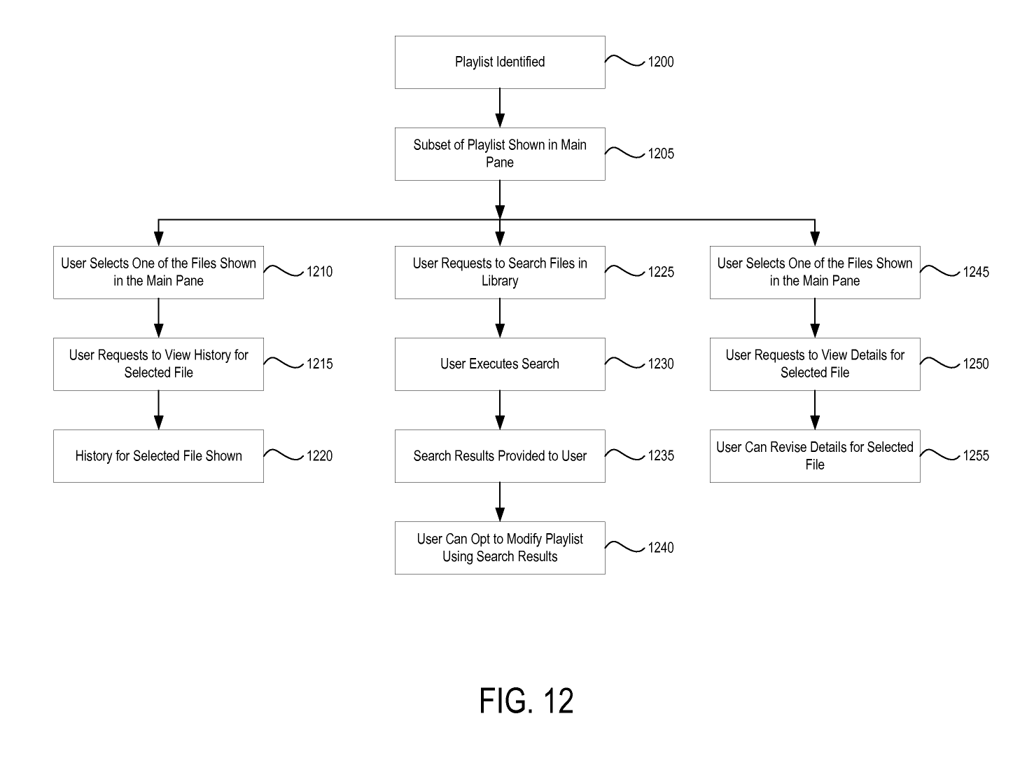

FIG. 12 shows a block diagram flow chart illustrating methods for displaying file history information, searching for files, and updating detailed information associated with files. A playlist is identified (1200) and a subset of the playlist is shown in the main pane 405 of a playlist editor UI (1205). For instance, the main pane 405 may display only those audio files for a particular hour or within a particular window of time, or only those scheduled to immediately precede or follow an ‘ON-AIR’ file, as is shown in the illustrative playlist editor UI 400 of FIG. 4. A user may select one of the files shown in the main pane 405 (1210). Subsequently the user can request to view the history for the selected file by selecting of the ‘history’ option from the user-selectable options 415 (1215), after which the history of the selected file is displayed in the history pane 910 (1220).

Using the playlist editor UI a user can also request to search all files in the library of files available to a radio station by selecting the ‘search’ option from the user-selectable options 415, as is shown in FIG. 5 (1225). The ‘search’ option presents the user with a search pane 510 that provides the user with all files in the library that fulfill the one or more terms input by the user in the search window 565. The user may then execute the search (1230). The search results are provided to the user (1235), who can choose to modify the playlist using the files identified in the search results (1240).

As is also shown in FIG. 12, a user can also select one of the files shown in the main pane 405 (1245) and then use the playlist editor UI to request to view the details of a file by selecting the ‘details’ option from the user-selectable options 415, as is shown in FIG. 6 (1250). Subsequently the user opt to modify the details for the selected file (1255), as described above with respect to FIG. 6.

Although described herein with respect to audio files, the systems and UIs of the present disclosure are operable to function with other types of files, including picture files, video files, and the like, regardless of format. Therefore, each of the functions described herein are equally applicable to other file formats, such as .tiff, .jpeg., wmv, mpeg, and the like. As a result, the present disclosure describes systems and UIs applicable for the management of any type of digital files.

Many modifications and other implementations will come to mind to one skilled in the art to which this disclosure pertains having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

That which is claimed:

1. A computer-implemented method for digital media management, the method comprising:
identifying a plurality of audio files;
associating at least one of the plurality of audio files with an origin code, wherein the origin code identifies one or more of the audio files having associated origin codes either as a music file or a traffic file; and
displaying the audio files identified by the origin code as either music files or traffic files.

2. The method of claim 1, wherein identifying a plurality of audio files comprises identifying at least one audio file of the plurality of audio files associated with respective scheduled play time.

3. The method of claim 2, wherein identifying a plurality of audio files further comprises identifying at least one audio file of the plurality of audio files that is not associated with a scheduled play time.

4. The method of claim 1, further comprising:
receiving an instruction from a user to display audio files identified by the origin code as either a music file or a traffic file; and
receiving a user selection of one of the plurality of audio files.

5. The method of claim 4, further comprising receiving a modification of the user selected one of the plurality of audio files.

6. The method of claim 5, wherein displaying the audio files further comprises displaying the modified user selected audio file.

7. The method of claim 4, wherein displaying the audio files further comprises displaying the audio files identified by the origin code as either a music file or a traffic file in a playlist.

8. The method of claim 7, wherein displaying the audio files further comprises displaying a status of the audio file or the time the audio file was added to the playlist.

9. The method of claim 8, wherein the status of the audio file comprises a pending status or a played status, wherein the pending status is associated with audio files that have not been executed in the playlist, and wherein the played status is associated with audio files that have already been executed in the playlist.

10. A method for digital media management, the method comprising:
identifying a plurality of audio files, wherein at least one of the plurality of audio files are associated with respective scheduled play times;
receiving a user request to view the audio files that are associated with a scheduled play time; and
displaying the audio files associated with a scheduled play time.

11. The method of claim 10, further comprising receiving at least one search query from the user; and
identifying audio files, of the plurality of audio files, that satisfy the at least one search query.

12. The method of claim 11, further comprising displaying the audio files that satisfy the at least one search query in a search results log.

13. The method of claim 11, further comprising receiving a user modification to at least one of the plurality of audio files.

14. The method of claim 13, wherein displaying the audio files associated with a scheduled play time comprises displaying the user modified at least one of the plurality of audio files.

15. The method of claim 14, wherein displaying the audio files associated with a scheduled play time comprises displaying metadata representing the user modification to the user modified at least one of the plurality of audio files.

16. The method of claim 10, wherein identifying a plurality of audio files further comprises identifying a plurality of audio files that are not associated with a scheduled play time.

17. The method of claim 10, further comprising:
receiving a user request to view the audio files that are not associated with a scheduled play time; and
displaying the audio files that are not associated with scheduled play times.

18. A method for digital media management, the method comprising:
identifying a plurality of digital media files;
displaying at least one of the plurality of digital media files to a user via a user interface, wherein the displayed at least one of the plurality of digital media files represent a playlist;
receiving a user selection of one of the digital media files displayed on the user interface; and
displaying a log associated with the user selected digital media file, wherein the log identifies historical information associated with the user selected digital media file.

19. The method of claim 18, further comprising updating the log in real time subsequent to a modification of the user selected digital media file.

20. The method of claim 18, wherein the historical information comprises the status of a digital media file or the time a digital media file was added to the playlist.

21. The method of claim 20, wherein the status of the file comprises a pending status or a played status of a digital media file, wherein pending status is associated with digital media files that have not been executed in the playlist, and wherein played status is associated with digital media files that have already been executed in the playlist.

22. The method of claim 18, further comprising receiving at least one search query from the user; and
identifying digital media files, of the plurality of digital media files, that satisfy the at least one search query.

23. The method of claim 22, further comprising displaying the digital media files that satisfy the at least one search query in a search results log.

24. A method for digital media management, the method comprising:
identifying a plurality of digital media files;
displaying at least some of the plurality of digital media files to a user via a user interface, wherein the displayed at least some of the plurality of digital media files represent a playlist;
displaying an indication that one of the displayed digital files is currently playing;
modifying at least one of the displayed media files in real time; and
updating the playlist to display the modified at least one displayed media file.

25. A system for digital media management, the system comprising:
means for identifying a plurality of audio files;
means for associating at least some of the plurality of audio files with an origin code, where the origin code identifies the at least some of the plurality of audio files as either a music file or a traffic file;
means for receiving an instruction from a user to display the audio files identified by the origin code as either a music file or a traffic file; and
means for displaying the audio files identified by the origin code as either a music file or a traffic file.
